(19) United States
(12) Patent Application Publication
(10) Pub. No.: US 2001/0022827 A1
(43) Pub. Date: Sep. 20, 2001

(54) Nuclear reactor fuel assembly with a high burnup

(75) Inventors: Gerhard Gradel, Forchheim (DE); Alfons Roppelt, Forchheim (DE); Rudolf Meinl, Adelsdorf (DE)

Correspondence Address: LAURENCE A. GREENBERG, P.O. Box 2480, Hollywood, FL, 33022, US

(73) Assignee: Siemens Aktiengesellschaft

(21) Appl. No.: 09/863,684

(22) Filed: May 23, 2001

Related U.S. Application Data
(62) Division of application No. 09/265,156, filed on Mar. 9, 1999.
Application No. 09/265,156 is a continuation of application No. PCT/EP97/04652, filed on Aug. 26, 1997.

(30) Foreign Application Priority Data
Sep. 9, 1996 (DE) 196 36 563.5

(51) Int. Cl. G21C 3/00

(52) U.S. Cl. 376/409

(57) ABSTRACT

A nuclear reactor fuel assembly with a high burnup is provided. In order to increase the burnup potential of fuel assemblies, pellets with an impermissibly high level of enrichment are produced on production lines, which are constructed for processing large quantities of normally enriched fuel. The impermissible level of enrichment is compensated for by the fact that, as early as in a powder mixer at an entry to the production line, so much absorber material is mixed with the fuel that the reactivity of the poisoned mixture does not exceed the reactivity of an unpoisoned fuel mixture with a normal level of enrichment. Corresponding fuel assemblies then contain relatively large quantities of these poisoned pellets (or only such poisioned pellets), which can be produced in large numbers (and therefore economically) by using conventional plants.

### CROSS-REFERENCE TO RELATED APPLICATION

This is a division of U.S. application Ser. No. 09/265,156, filed Mar. 9, 1999, which was a continuation of copending International Application No. PCT/EP97/04652, filed Aug. 26, 1997, which designated the United States.

### BACKGROUND OF THE INVENTION

1. Field of the Invention

The invention relates to a nuclear reactor fuel assembly with a high burnup, that is to say, for example, a nuclear reactor fuel assembly having a burning life of 5 or more cycles, and a corresponding level of enrichment with fissile or fission material, which corresponds to more than 5% U₂₃₅. The invention is based on a fuel assembly for a light-water reactor, in which enriched fissile material, absorber material, metal cladding tubes for fuel rods and structural parts of the fuel assembly are kept ready. A powder mixture containing enriched fissile material is produced in equipment in a part of a production plant containing at least one powder mixer. The capacity of the equipment, specifically at least the volume of the powder mixer, is selected for a volume that can still be handled safely only in the case of an unpoisoned fissile material with a level of enrichment below a maximum value. In a second part of the production plant, a fuel powder made of an enriched fissile material and absorber material is compressed to form pellets and sintered, and the fuel assemblies are produced from the sintered pellets, the cladding tube and the structural parts. The capacity of the equipment in the second part also does not exceed that maximum volume of an unpoisioned fissile material having a level of enrichment below the maximum value, which can still be handled safely.

In pressurized-water reactors, some fuel assemblies, having a usable energy content in the form of enriched nuclear material which has been used up, are replaced at regular intervals (for example yearly) by fresh, unpoisoned fuel assemblies. The production of such unpoisoned fuel assemblies is illustrated in FIG. 1 and described in detail below. The production of poisoned fuel assemblies is illustrated in FIG. 2 and is also described in detail below.

The difficulties encountered with the prior art fuel assemblies and processes for the production thereof, which are also described in more detail below, has been with enrichment and the requirement for time-consuming and complicated changes to previous technology.

### SUMMARY OF THE INVENTION

It is accordingly an object of the invention to provide a nuclear reactor fuel assembly with a high burnup, which overcome the hereinafore-mentioned disadvantages of the heretofore-known devices and methods of this general type, which produce fuel assemblies with a fissile material that is enriched to such an extent and which provide corresponding fuel assemblies and fuel elements, so that time-consuming and complicated changes do not have to be made to previous technology.

The invention is based on the fact that, in principle, it is not the enrichment of the fissile core material itself but only its reactivity and the reactivity of the finished fuel assemblies which is the safety-relevant parameter. Instead of starting from the overall enrichment level of the fissile material, in order to maintain safety it is physically expedient to subtract from that level of enrichment that part which may, if appropriate, be compensated for by burnable neutron poison which has already been added. Attention should therefore be focused on the reactivity of the powder used in each case, of the resulting pellet and of the fuel assembly. In that case, reactivity and enrichment are equivalent in terms of processing an unpoisoned powder mixture and, for the handling which was previously considered to be safe, the plant according to FIG. 1 can still be used only with fissile material having a level of enrichment which does not exceed the maximum value, for example 5%. However, the equipment of FIG. 1 according to the invention is used, with the same degree of safety to process a powder material in which the level of enrichment of the fissile material is above that above-mentioned maximum value, but in which the powder material also contains such a quantity of absorber material that the reactivity of the poisoned powder mixture corresponds to the reactivity of an unpoisoned powder mixture having a level of enrichment that is not above the above-mentioned maximum value. The corresponding pellets then have the required lower reactivity, although they have a higher level of enrichment (“burnup potential”). In the production of fuel assemblies having a higher burnup, e.g. 60 to 70 MWd/kg (U), it is particularly advantageous not only to provide some of the fresh fuel assemblies but all of the fuel assemblies in a pressurized-water reactor with poisoned pellets having a level of enrichment which is above a value of about 4 to 5% (e.g. 6 to 8%). It may even be advantageous, even in the case of a boiling-water reactor, to enrich and to poison all of the pellets in the fuel assemblies to a correspondingly high level. The high production capacities which were previously used only for unpoisoned pellets are then also completely utilized in that way. From the point of view of safety, the storage of such poisoned fuel assemblies does not result in any changes with respect to the previous fuel assemblies. With the foregoing and other objects in view there is provided, in accordance with the invention, a process for producing a fuel assembly for a light-water reactor, which comprises providing enriched fissile material, absorber material, metal cladding tubes for fuel rods and structural parts of a fuel assembly; producing a powder mixture containing enriched fissile material in equipment in a first part of a production plant containing at least one powder mixer, selecting a capacity of the equipment, including at least a volume of the powder mixer, for a volume that can still be handled safely only in the case of an unpoisoned fissile material with a level of enrichment below a maximum value; compressing the fuel powder made of the enriched fissile material and absorber material to form pellets and sintering, in a second part of the production plant, producing the fuel assemblies from the sintered pellets, the cladding tube and the structural parts, additionally limiting a capacity of equipment in the second part so as not to exceed a maximum volume of an unpoisioned fissile material having a level of enrichment below a maximum value which can still be handled safely; and as early as in the powder mixer, producing a powder poisoned with the absorber material as the powder mixture, using the poisoned powder as a fuel powder for at least some of the pellets, setting a level of enrichment of the poisoned powder in the powder mixer above a maximum value of the fissile material and setting such a quantity of absorber material that a maximum reactivity of the powder material is equivalent to a reactivity of an unpoisoned fissile material of the same volume having been enriched to the maximum value.

In accordance with another mode of the invention, there is provided a process which comprises keeping the enriched fissile material ready in individual containers having a volume which is a fraction of the capacity of the powder mixer, and mixing a powder made of the absorber material with the contents of a number of the containers, in the powder mixer.

In accordance with a further mode of the invention, there is provided a process which comprises including at least one of uranium dioxide and plutonium oxide in the enriched fissile material.

In accordance with an added mode of the invention, there is provided a process which comprises including gadolinium in the absorber material.

In accordance with an additional mode of the invention, there is provided a process which comprises including a material selected from the group consisting of boron and a boron compound, in the absorber material.

In accordance with yet another mode of the invention, there is provided a process which comprises including a rare earth in the boron compound.

In accordance with yet a further mode of the invention, there is provided a process which comprises mixing a powder with boron-containing particles provided with a protective coating with a powder made from the enriched fissile material, to produce the poisoned powder.

In accordance with yet an added mode of the invention, there is provided process which comprises producing pellets in all of the fuel rods of the fuel assemblies, preferably all of the pellets in all of the fuel rods of the fuel assemblies from the powder having the level of enrichment above the maximum value but having been poisoned with the absorber material.

In accordance with yet an additional mode of the invention, there is provided a process which comprises using cladding tubes having a hafnium content above a permissible limiting value of a hafnium content in reactor-pure zirconium.

In accordance with again another mode of the invention, there is provided a process which comprises setting the level of enrichment of the enriched fissile material to be more than 5% by weight of U₂₃₅, preferably more than 6%, or more than a corresponding value for fissile plutonium.

With the objects of the invention in view, there is also provided a process for producing a fuel assembly, which comprises compressing enriched fissile material and an absorber material to form poisoned pellets and sintering the poisoned pellets; additionally processing natural uranium or depleted uranium to form sintered, unpoisoned neutral pellets, if appropriate; assembling pellet columns only from the poisoned pellets and, if appropriate, from the neutral pellets and enclosing the pellet columns in metal cladding tubes; and assembling a fuel assembly from structural parts and the metal cladding tubes filled with the columns of pellets.

With the objects of the invention in view, there is additionally provided a fuel assembly, comprising fuel rods containing pellets having a fissile material with a level of enrichment above a maximum value permitted for safe processing of an unpoisoned enriched fissile material, and absorber material added to lower a reactivity of the pellets below a reactivity of an unpoisoned pellet made of the unpoisoned fissile material enriched to a maximum value.

In accordance with another feature of the invention, the pellets in all of the fuel rods, preferably all of the enriched pellets in all of the fuel rods, contain the fissile material.

In accordance with a concomitant feature of the invention, all of the fuel rods in the fuel assembly contain only pellets with the fissile material, and if appropriate, pellets made of non-enriched material.

Other features which are considered as characteristic for the invention are set forth in the appended claims.

Although the invention is illustrated and described herein as embodied in a nuclear reactor fuel assembly with a high burnup, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic illustration of process steps and equipment used for the production of unpoisoned fuel assemblies;

FIG. 2 is a diagrammatic illustration of process steps and equipment used for the production of poisoned fuel assemblies; and

FIG. 3 is a diagrammatic illustration of process steps and equipment used for an exemplary embodiment of the process according to the invention.

### DESCRIPTION OF THE PREFERRED EMBODIMENTS

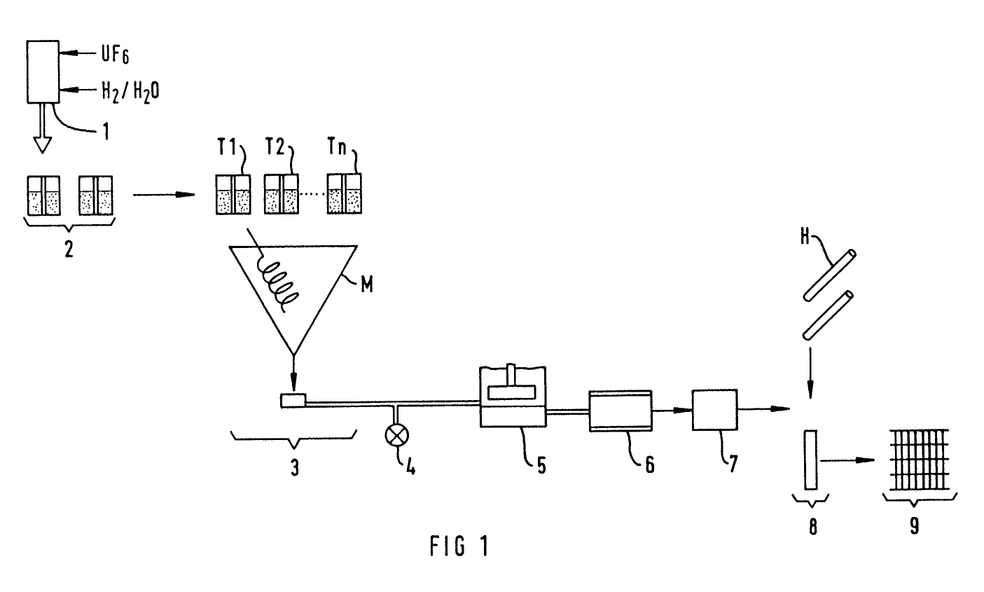

Referring now to the figures of the drawings in detail and first, particularly, to FIG. 1 thereof, there is seen an illustration of a production of unpoisoned fuel assemblies, in which a starting point is enriched fissile or fission material that is kept ready in transport containers T1, T2, . . . Tn. The transport containers are supplied from a conversion plant 1, in which a uranium dioxide powder is produced from a uranium compound. The uranium of the uranium compound contains natural uranium (primarily the uranium isotope U₂₃₈ which cannot be used directly for the chain reaction of the reactor), and the uranium isotope U₂₃₅ which is important for the chain reaction. The content of U₂₃₅, that is to say the “enrichment”, is generally restricted on safety grounds and, in any case, is not allowed to exceed a maximum value (generally 5%).

In the conversion plant 1, the oxide powder which is produced, for example from UF₆ by reduction in a H₂/H₂O gas, is put into the transport containers T1, T2, . . . Tn in a filling station 2. The volume of the transport containers T1, T2 . . . . Tn is relatively small (for holding only 100 kg UO₂ powder, for example). In other words, they include only a subcritical quantity of fissile material in all cases, and in addition are provided with rods S and/or a lining made of neutron-absorbing material.

A production plant includes a first part 3 having a powder storage device and equipment for powder processing, of which only a powder mixer M is illustrated in FIG. 1. The powder mixer M may, for example, be a large mixing container with a stirrer and a bottom at which a powder mixture is drawn off. The powder is formed of the carefully homogenized contents of the transport containers T1, T2, . . . Tn which have been emptied into the powder mixer M. This powder mixture can be conveyed (for example extracted by suction or blown through the use of compressed air) into a second part of the production plant, for example through a powder delivery line and other equipment in the first part. In the process, samples of the powder mixture are continuously examined at an analysis station 4, in order to monitor the homogeneity, fissile material enrichment and quality of the mixture. In addition, it may be necessary to admix lubricants and pressing aids to the fissile material and/or to carry out suitable granulation operations on the powder.

The equipment in this first part of the production plant is constructed, with regard to its capacity, in such a way that it is able to hold so much powder that a filling of highly enriched material would come dangerously close to the critical mass and would no longer be able to be handled safely. For safety reasons, therefore, a maximum value for the level of enrichment (for example 5%) is defined, and the capacity of the production equipment is selected in such a way that the fissile material cannot reach the critical mass even at the highest permitted enrichment value, that is to say it can be handled safely. Thus, for example, the volume and the criticality of the powder mixer M are as a rule constructed for 1 to 4 tons, so that even a filling of an unpoisoned powder mixture with the permitted maximum value of, for example, 5% U₂₃₅ cannot approach the critical mass.

In the second part of the production plant, this powder mixture is processed further, with a pellet press 5 producing pellet slugs which are sintered in a sintering furnace 6. These pellets are ground to their final shape, measured and weighed in a quality stage 7 and they are finally enclosed in appropriate metal cladding tubes H in a filling station 8. The metal cladding tubes H are generally are formed of zirconium alloy (for example Zirkaloy). An assembling station 9 assembles these cladding tubes and other structural parts S of the fuel assembly, such as top pieces, bottom pieces and spacers, as well as guide tubes or fuel cans, to form a finished fuel assembly (FA). These cladding tubes, which have been filled and welded so as to be gas tight through the use of metallic end pieces, are the fuel rods (FR).

In addition to such unpoisoned fuel assemblies, use is also made of “poisoned fuel assemblies”, in order to replace some of the burned-up fuel assemblies in a pressurized-water reactor. In addition to the enriched fissile material, these “poisoned fuel assemblies” contain a burnable neutrons absorber, that is to say an absorber material, having an absorption capacity for thermal neutrons that decreases with increasing service life in the reactor. This “burnable neutron poison” neutralizes some of the neutrons being emitted by the enriched material as a result of nuclear fission. However, after one operating cycle the absorption effect has already decayed to a residual, virtually negligible absorption capacity. This makes it possible to maintain the value of neutron flux, for which the reactor is constructed and optimized, virtually over the entire operating cycle and to compensate for the reactivity of the fresh fuel assemblies which goes beyond this (excess reactivity).

In the case of pressurized-water reactors, the practice until now has therefore been to use unpoisoned and poisoned fuel assemblies alongside one another. In the case of boiling-water reactors, it is common to use different levels of enrichment for the individual fuel rods of each fuel assembly, in order to achieve uniform burnup of the fissile material and optimum utilization. In this case, all of the fuel assemblies in the core then generally contain unpoisoned pellets and pellets with poisoned fuel. These pellets form the “active zone” of the fuel assemblies and, for reasons concerned with thermal insulation and in order to confine the neutron flux in three dimensions, are often further surrounded by neutral pellets which include natural uranium, depleted uranium or other, virtually nonfissile oxide.

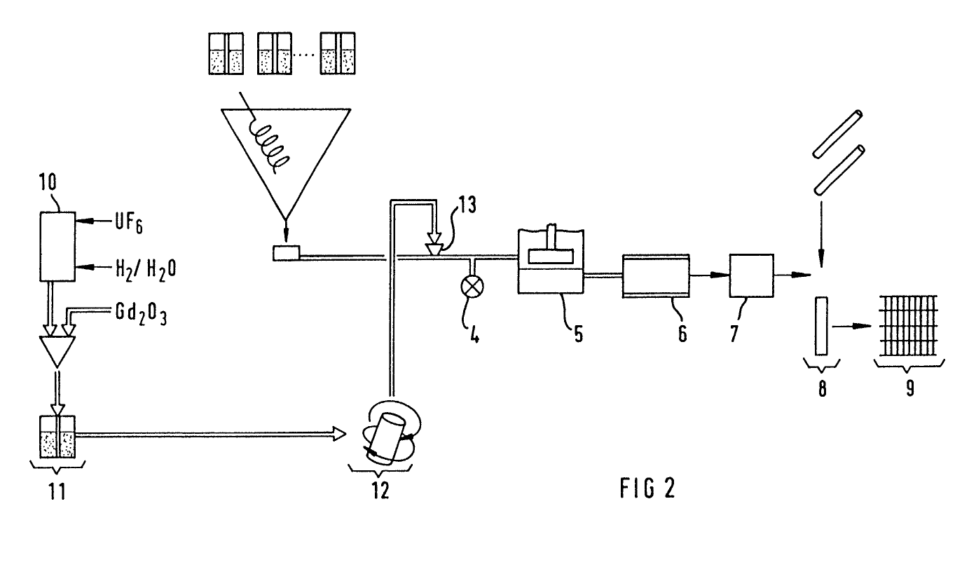

The production of poisoned fuel assemblies is shown diagrammatically in FIG. 2. In this case, the relatively expensive burnable neutron poison (generally gadolinium oxide Gd₂O₃) is admixed to just a few pellets in a fuel assembly. The powder mixture is produced in a special part of the production plant, while the conversion plant 1, the filling station 2 and the equipment with the powder mixer M in the first part 3 of the production plant is used for mixing the powder of the other pellets. The second part of the production plant with the pellet press 5, the sintering furnace 6, the quality stage 7, the filling station 8 and the assembling stage 9 can be used jointly. In a feed station 13, the fuel powder of the poisoned pellets is removed from transport containers V, which originate from a conversion plant 10. There, the neutron poison has already been added to the fissile material during the conversion of the uranium compound, or has been mixed with the uranium dioxide powder produced by the conversion. For the purpose of homogenization, the poisoned fuel powder is generally firstly put into the transport containers V in a filling station 11 and fed to a tumble mixer 12 to homogenize the mixture.

In principle, other burnable neutron poisons can also be used instead of gadolinium. In particular, the nuclear properties of boron appear to be particularly interesting for that purpose. However, elementary boron or a compound containing boron cannot simply be added to the uranium dioxide powder, since a very volatile boron compound is then formed and cannot be kept in the pellets, but is driven out of the pellet at temperatures in a reducing or inert gas atmosphere which is used for sintering. It has therefore already been proposed to firstly coat the finished pellets with boron. That coating layer can be sprayed on by using a plasma process, or can be applied by being deposited from an appropriate vapor phase, through the use of sputtering or by other methods. One example is described in U.S. Pat. No. 3,427,222. In that case, the coating layer may be formed of a number of layers, in order to apply an adhesive intermediate layer and/or a protective layer, and/or to improve the absorber properties by introducing a further absorber material with a variable nuclear behavior. In German Published, Non-Prosecuted Patent Application DE 34 02 192 A1, corresponding to U.S. Pat. Nos. 4,582,676 and 4,587,087, UO₂ is coated with niobium (3 μm to 6 μm thickness), on which ZrB₂ is then deposited chemically from the vapor phase.

In order to produce poisoned fuel assemblies, it has also already been proposed to introduce boron into the fuel assemblies in the form of dedicated small absorber elements. Thus, for example, steel tubes which are filled with boron glass can be introduced through dedicated holders (so-called “boron glass webs”) into guide tubes of fuel assemblies which are not needed to control the reactor operation and into which, therefore, no control rods are introduced. It has also already been proposed to produce microparticles containing boron (for example from ZrB₂), which are also protected by a coating (for example of molybdenum). Therefore, instead of the gadolinium oxide powder in FIG. 2, it is possible in principle to mix a powder made of such molybdenum-protected microparticles with the uranium dioxide powder and to put it into the transport containers V.

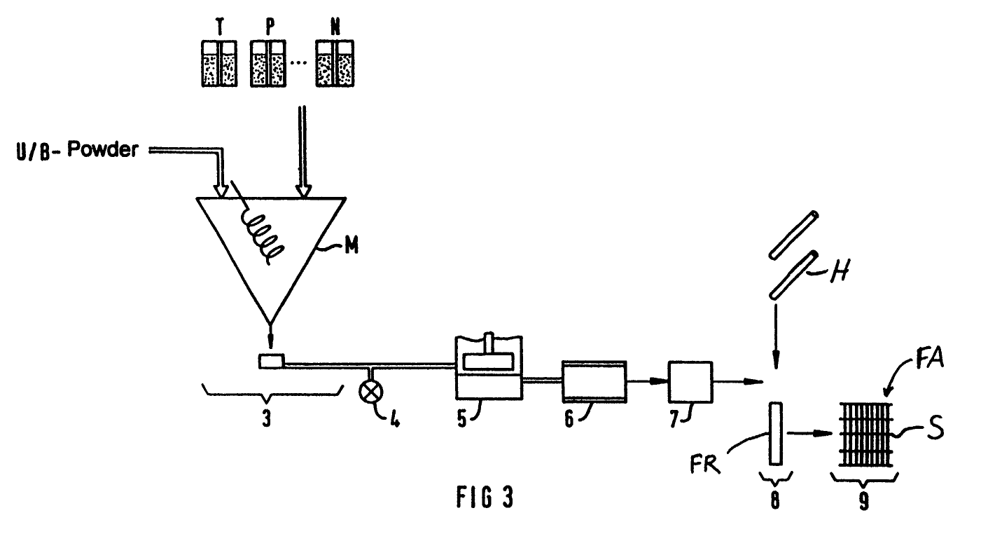

Spent fuel assemblies still contain fissile plutonium, which can be separated from the spent fissile material in appropriate reprocessing plants, in order to use that plutonium instead of the fissile U₂₃₅ to enrich fissile material for fresh fuel assemblies. In order to produce fuel assemblies from a mixed oxide of that type (MOX, that is to say a mixture of uranium dioxide and plutonium oxide), use is made of equipment in the special part of the production plant shown in FIG. 2. For this purpose, transport containers P (shown in FIG. 3) which are supplied from the reprocessing plant and filled with plutonium oxide, and oxide of natural uranium (or depleted uranium from reprocessing) as well as the absorber material needed, can be put into the transport containers V in the filling station 11 and homogenized in the tumble mixer 12. The poisoned fuel powder is then fed into the second part of the production plant, that is to say into the elements 5 to 9 of FIGS. 1 and 2, for example, through the feed station 13.

It is normally the case that after each fuel cycle approximately ¼ of the fuel assemblies are virtually spent and must be replaced by new fuel assemblies. Therefore, the average lifetime of the fuel assembly was approximately four years until now, with that period of use being determined not only by the energy content (level of enrichment) of the fissile material but also by the material properties of the cladding tubes. It has therefore also previously been the case that fuel elements from regions in which weaker burnup takes place could only be used for a relatively long time if, for example, sufficient corrosion-resistant cladding-tube material was available. In the meantime, cladding tubes, structural materials and fuel element structures have been developed which also permit a longer period of use (for example 6 to 7 years). In principle, that permits considerable savings in terms of replenishing with fresh fuel assemblies and the disposal of the spent fuel assemblies, since it would then be necessary in each case to replace only ⅙ to 1/7 of the fuel assemblies. However, that presupposes a correspondingly high level of enrichment, which would have to be, for example, about 6 to 8% U₂₃₅. That is a value at which, for example, the volume of the powder mixer M in FIG. 1, were it to be filled with a fissile material enriched in this way, would exceed the maximum volume which is sufficiently remote from the critical mass and which is still permitted for safe handling. It would then also no longer be permitted to use the quantities of pellets or filled fuel rods which were previously kept ready in stock in production. For those reasons, the use of fissile material which has been enriched beyond a defined maximum value of 4 to 5% U₂₃₅, or a corresponding content of plutonium, has until now generally not been permitted. For those practical reasons, the potential for savings which has been created by the advances in reactor technology cannot be utilized, although that should be possible in theory.

That is because highly enriched fuel can only be stored and transported, for example, in protective containers with a small volume and neutron-absorbing fittings. Although it has already even been proposed to use only plutonium without natural uranium enclosed in cladding tubes made of hafnium for fuel assemblies, pellets which have subsequently been coated with boron have previously been considered only in connection with the above-mentioned reactor physics of conventional poisoned fuel assemblies. However, in that way it should also be possible to use fuel which would be enriched above the previous maximum value in order to increase the burnup.

However, the production of such highly enriched pellets on an industrial scale appears to require particularly safe production processes and special equipment. Although, as was already the case with the heretofore separately produced poisoned pellets, one might consider using only a few special pellets in each case, to be produced with such special equipment, together with the largest possible number of the usual, normally enriched pellets, which are easier to produce, special production would not be practical because of the small numbers.

A further restriction on the enrichment results from the requirement that the finished fuel assemblies must be sufficiently far from criticality when (for example in a dispatch storage space or during transportation) they inadvertently come into the vicinity of relatively large quantities of water (for example fire fighting water in the event of a fire). For that reason, conventional fuel assemblies of the 16×16 type or 18×18 type must not have a level of enrichment above 4.4% (the limiting value is somewhat higher for the 17×17 type). Safety would also be ensured if relatively large quantities of absorber material were to be incorporated into the structure of the fuel assembly. However, that makes fundamental changes in the construction or structural material of the fuel assemblies necessary, or special pellets containing absorber have to be used. At the present time, there are no concepts available for either route which could be implemented rapidly and economically. Instead, attempts are being made to prolong the period of use of the fuel assemblies without exceeding the enrichment limits by better utilizing the previously available burnup potential.

However, it should also be possible, with regard to the required safety, to provide fuel assemblies which permit the safer use of highly enriched fissile material, and to modify the production processes and safety regulations appropriately.

FIG. 3 shows an exemplary embodiment of an inventive process and equipment for performing the process, in which the enriched fissile material is kept ready in transport containers T, P and N that are supplied by the conversion plant or reprocessing plant and are filled with enriched fissile material, plutonium-containing powder and powder with natural uranium, or in some other way. Likewise, cladding tubes H and the other structural parts which are needed for the production of fuel assemblies are kept ready. Furthermore, it is assumed that there is a supply of absorber material which, for example, may be formed of gadolinium oxide in accordance with the prior art.

The fuel powder to be processed in the pellet press is produced by the powder mixer M being used to make a powder mixture. On one hand, the powder mixture contains fissile material with a level of enrichment above the maximum value. On the other hand, this powder mixture contains such a quantity of absorber material that the reactivity of the powder mixture has a maximum reactivity which is equivalent to the reactivity of an unpoisoned fissile material enriched to the maximum value.

Of course, the enriched fissile material corresponding to FIG. 3 may be a mixture of plutonium dioxide, natural (or depleted) uranium dioxide and enriched uranium dioxide, but it is equally possible to use only depleted uranium dioxide and plutonium oxide, only enriched uranium dioxide or another suitable fissile material. This stock of highly enriched fissile material can be managed without problems, in particular if the material is put into a large number of individual containers having a volume which is only a fraction of the capacity of the powder mixer M. These containers may, in particular, be formed of an absorber-containing material and/or may contain additional absorbing structural elements. In the powder mixer, the absorber material is mixed homogeneously with the contents of a number of such containers. The absorber material may be present, in the conventional way, as gadolinium oxide, which can be mixed in a known way with the powder of the fissile material, either directly or following additional measures for granulation and setting desired grain sizes, can be pressed into pellets and sintered. Through the use of trials on a laboratory scale, beneficial behavior during mixing, compression and sintering has also been demonstrated for powders made of ZrB₂ particles which have been coated with molybdenum and mixed with uranium dioxide powder. This is because the burnup behavior of boron complies with the requirements on the absorber of highly enriched fuel assemblies constructed for a long period of use. In a similar way, borides of rare earths such as gadolinium, erbium, eurobium, samarium and so on or else hafnium are also suitable. Absorber powders which contain metal (e.g. hafnium, tantalum) also appear to be suitable. It is particularly advantageous to use not just one neutron-absorbing chemical element but a number of elements, in particular two elements. Thus, “dual absorbers” such as GdB₂, GdB₄ or GbB₆ permit the production of MOX fuel assemblies having an increased content of fissile plutonium. It is therefore possible to exert a beneficial influence not only on the storage properties of the fresh fuel and of the fresh fuel assemblies but also on the behavior of fuel assemblies in the reactor.

The standard dimensions and standard materials can be used for the cladding tubes and structural parts. However, while an extremely low content of hafnium is usually stipulated for reactor materials, hafnium contents of up to 2% are quite possible in this case. As a result, further costs are saved since, for example, zirconium sponge (the most common basic metal for alloys in nuclear technology) can only be freed of hafnium in an expensive way.

If it is planned to reprocess fuel assemblies having a level of enrichment of about 5% U₂₃₅ after a burnup of 60 MWd/kg (or corresponding fuel assemblies constructed for even higher burnup values) following their use in the reactor, then poisoning with boron may lead to problems in reprocessing, which can be avoided by poisoning with gadolinium. However, on the basis of fundamental considerations, the reprocessing of such extensively spent fuel assemblies may no longer appear to be worthwhile. Boron poisoning is therefore primarily suitable for fuel assemblies which are to be directly finally stored following use in the reactor.

In order to make the long periods of use of the fuel assemblies possible, it is advantageous if the fuel assemblies contain grids not only at the levels at which the fuel rods have to be supported on spacer grids for mechanical reasons, but also at intermediate levels. These intermediate grids are then provided with mixing devices in order to obtain better cooling of the highly enriched fuel rods by mixing the coolant. It is also advantageous if the cladding tubes are made particularly corrosion-resistant, for example by being formed of a mechanically stable tube of a zirconium alloy. It is likewise advantageous if they contain a thin coating of a corrosion-resistant material on the outer surface which is exposed to the coolant, as is described in European Patent Application 0 301 295 A1. In this way, the fuel assembly is adapted to a long period of use not only with regard to its energy content and the fissile material enrichment level, but also with regard to the other chemical and physical conditions.

In order to increase the burnup potential of fuel assemblies, pellets with an impermissibly high level of enrichment are therefore produced on the production lines (3 to 9), which are constructed for processing large quantities of normally enriched fuel. The impermissible level of enrichment is compensated for by the fact that, in the powder mixer (M) at the entry to the production line, so much absorber material (U/B powder) is already mixed with the fuel (T, P, N) that the reactivity of the poisoned mixture does not exceed the reactivity of an unpoisoned fuel mixture with a normal level of enrichment.

Corresponding fuel assemblies then contain relatively large quantities of these poisoned pellets (or, if appropriate, only such poisoned pellets in addition to the above-mentioned neutral pellets), which are produced in large numbers (and therefore economically) using the conventional plants. In order to produce such fuel elements, enriched fissile material and an absorber material are then compressed to form poisoned pellets and, if required, neutral pellets are also produced from unenriched material which is virtually not fissile (for example natural uranium or depleted uranium). These pellets are made up into columns which are formed only of such poisoned pellets and, if appropriate, further neutral pellets and are enclosed in metal cladding tubes. In this way, fuel rods are produced, which are then assembled, together with the structural parts (if appropriate, including control rod guide tubes or water-filled rods, but without using unpoisoned fuel rods) to form the fuel assembly.

We claim:

1. A fuel assembly, comprising:
fuel rods containing pellets having a fissile material with a level of enrichment above a maximum value permitted for safe processing of an unpoisoned enriched fissile material, and absorber material added to lower a reactivity of said pellets below a reactivity of an unpoisoned pellet made of the unpoisoned fissile material enriched to a maximum value.

2. The fuel assembly according to claim 1, wherein said pellets in all of said fuel rods contain the fissile material.

3. The fuel assembly according to claim 1, wherein all of said enriched pellets in all of said fuel rods contain the fissile material.

4. The fuel assembly according to claim 1, wherein all of said fuel rods in the fuel assembly contain only pellets with the fissile material.

5. The fuel assembly according to claim 1, wherein all of said fuel rods in the fuel assembly contain only pellets with the fissile material and pellets made of non-enriched material.
